(19) United States
(12) Patent Application Publication
(10) Pub. No.: US 2009/0186260 A1
(43) Pub. Date: Jul. 23, 2009

(54) Accumulator, Accumulator Group and Method for Production Thereof

(76) Inventor: Rolf Wiepen, Schwerte (DE)

Correspondence Address: FOLEY AND LARDNER LLP;SUITE 500, 3000 K STREET NW, WASHINGTON, DC, 20007, US

(21) Appl. No.: 11/992,410

(22) PCT Filed: Sep. 13, 2006
(86) PCT No.: PCT/DE2006/001624

§ 371 Date: Mar. 11, 2009

(30) Foreign Application Priority Data
Sep. 23, 2005 (DE) 10-2005-045-418.6

(51) Int. Cl. H01M 2/12; H01M 2/00; H01M 2/02; H01M 6/42; H01M 4/82

(52) U.S. Cl. 429/53; 429/163; 429/181; 429/159; 29/623.2

(57) ABSTRACT

A rechargeable battery includes negative electrode plates that are connected to an output contact sheet which has bent-around contact lugs. The contact lugs extend from the second side edge to the first side edge of the electrode plate stack, whilst in a sprung manner on the inner face of the housing and form an electrical contact with the housing. The rechargeable battery also includes a connection profile which can be electrically and mechanically connected to connecting contacts of the positive electrode plates and has a U-shaped base section extending parallel to the cover. Two parallel flank sections are provided, which extend away from the base section and are arranged in order to surround and to make electrical contact with the housing of an adjacent rechargeable battery.

### CROSS-REFERENCE TO RELATED PATENT APPLICATIONS

The present application is a National Stage of International Application No. PCT/DE2006/001624 filed on Sep. 13, 2006, which claims priority to German Priority Application DE 10 2005 045 418.6, filed Sep. 23, 2005.

### BACKGROUND

The present invention relates to a rechargeable battery and a rechargeable battery block having a multiplicity of rechargeable batteries, and a method for production of rechargeable batteries and rechargeable battery blocks.

High-performance battery systems are required, for example, as an energy storage system in hybrid vehicles. They have to be able to emit high power levels for short time periods and to be able to absorb high electrical power levels within short time intervals. In the extreme, these discharging and recharging processes follow one another closely in time. Since both discharging and charging processes are associated with energy losses by (resistive or electrochemical) polarization, these energy losses result in a considerable amount of heat being formed during continuous operation of battery systems. This can lead to considerable heating of the cells and thus to a restriction to their operating range. For example, in the case of nickel metal hydride NiMH or nickel cadmium NiCd rechargeable batteries, full power levels are available only up to 60% of the state of charge at high temperatures.

On the other hand, high operating temperatures in batteries can lead to their life being shortened. These processes which shorten the life are caused by chemical processes at the electrodes, which continuously reduce the storage capability of the materials and the rate at which they can absorb electrical power. High temperatures can also lead to loss of the liquid electrolyte, which can migrate through the sealing materials, which become increasingly permeable at high temperatures. In particular, electrochemical storage systems which use plastic as housing materials may be affected by high electrolyte losses through these diffusion/permeation processes.

In an NiMH system, which has nowadays been increasingly used in hybrid vehicles, it is also possible for hydrogen to be lost through the walls of plastic housings, as a damaging effect. Since hydrogen which is incorporated in the hydrogen storage alloy represents the actual active negative electrode material, its loss can considerably interfere with the operation of the storage system.

Steel is preferably used for the battery housings for alkaline batteries and, in a thin form, not only protects against water permeation but also largely prevents hydrogen permeation. However, the design options with steel are disadvantageously restricted, particularly in thin-walled embodiments. Thin-walled housings are, however, essential for weight-saving reasons.

Since, when they are designed to be gas-tight, rechargeable batteries can build up internal pressure in certain operating states (high temperature, overcharging, etc.), a robust housing is required which at the same time can also efficiently transport heat away.

One ideal technical solution is represented by cylindrical steel cells, such as those which are nowadays widely used for appliance battery applications. Cylindrical forms are robust, even against high pressures. In consequence, this allows thin-walled metal vessels to transfer heat quickly. However, the cylindrical configuration is restricted to relatively small cells. As the cell capacity increases, the diameter increases, making it more difficult to dissipate heat from the interior.

One form which is fundamentally advantageous for heat transfer is represented by flat, prismatic rechargeable batteries, which can be joined together to form rechargeable battery blocks.

S. Hamada, T. Asahina, T. Matsuurah, H. Miyamoto, T. Ito: “Development of New Prismatic Type Ni-MH Battery for HEV”, in: Proceedings of the 5th Advanced Automotive Battery Conference, Honolulu, Hi., Jun. 13-17, 2005, Session 4, No. 16 describes a rechargeable battery with a metal housing in which an output contact sheet which is connected to the negative electrode plates is welded to the battery housing. Positive pole connections are passed out of the metal housing on its opposite side and are electrically insulated from the housing by an insulating cage. Mutually adjacent rechargeable batteries are connected by welding the positive connections to the housing connecting contact plate, which forms the negative pole.

A gas pressure-reliefvalve is passed out of the housing, with the gas pressure-relief valves of a row of rechargeable batteries being connected to one another via a gas outlet channel which is plugged onto the gas pressure-relief valves.

The rechargeable battery block is coated with an insulating film, in order to prevent shorts.

A similar embodiment of rechargeable batteries is described in T. Hayashi, M. Ito, T. Ishishita, Y. Arase: “Development of New Battery System for Hybrid Vehicles”, in: Proceedings of the 5th Advanced Automotive Battery Conference, Honolulu, Hi., Jun. 13-17, 2005, Session 4. In this case as well, a metal housing is proposed for the rechargeable battery and the electrodes are directly welded to the battery housing and to the positive pole, in order to save connection space.

U.S. 2004/0248002 A1 describes a prismatic rechargeable battery in which the positive pole is passed through a hole in the cover of the housing. The positive pole can be deformed in the form of a rivet and pinches a sealing ring which is passed through the hole, when the positive pole is being attached to the cover. Once the electrode plate stack has been inserted into the housing and the cover has been closed, the positive pole rests on an output contact sheet for the positive electrode plates. The cover is then welded to the housing, and the positive pole can be laser-welded to the output contact sheet for the positive electrode plates, with the assistance of the hollow form of the rivet-like positive pole.

DE 101 44 281 A1 describes a round cell in which wound electrodes are welded to an output sheet having contact lugs. The contact lugs are bent such that they rest on inner surfaces of a housing cup.

JP 2000-048803 discloses a rechargeable battery in which the positive and negative electrode plates each make contact with a threaded bolt by a housing cover. In this case, an insulating sleeve surrounding the threaded bolt and a sealing ring are provided in the interior adjacent to the housing cover, and are arranged aligned with an aperture in the housing cover for a threaded bolt. The threaded bolt, the insulating sleeve, the sealing ring and the housing cover are braced by a nut.

In conventional rechargeable batteries, one problem is the tight manufacturing tolerances that are required in order to ensure reliable sealing and optimum contact.

### SUMMARY

An exemplary embodiment of the invention relates to a rechargeable battery having a cuboid housing, an electrode plate stack, which has a multiplicity of positive and negative electrode plates which are separated from one another by intermediate separators and are arranged alternately one above the other, as well as electrolyte in the housing, which has an opening (which can be closed by a cover for insertion of the electrode plate stack, with the positive electrode plates being connected to one another on a first side edge of the electrode plate stack, with the negative electrode plates being connected to one another on the second side edge, opposite the first side edge, of the electrode plate stack, and with the negative electrode plates making electrical contact with the inner face of the housing. The rechargeable battery includes negative electrode plates that are connected to an output contact sheet which has bent-around contact lugs, and the contact lugs extend from the second side edge to the first side edge of the electrode plate stack, whilst in a sprung manner on the inner face of the housing and form an electrical contact with the housing. The rechargeable battery also includes a connection profile which can be electrically and mechanically connected to connecting contacts of the positive electrode plates and has a U-shaped base section extending parallel to the cover, and two parallel flank sections are provided, which extend away from the base section and are arranged in order to surround and to make electrical contact with the housing of an adjacent rechargeable battery.

Another exemplary embodiment relates to a method for production of rechargeable batteries and rechargeable battery blocks having the following steps:

a) insertion of an electrode plate stack having an output contact sheet, which has sprung contact lugs on the negative electrode plates into the housing of the rechargeable battery such that the contact lugs rest in a sprung manner against the inner face of the housing, and at least one connecting contact threaded rod on the side edge opposite the output contact sheet of the electrode plate stack projects out of the opening in the housing through which the electrode plate stack is inserted into the housing;

b) fitting of sealing rings to the at least one connecting contact threaded rod (10),

c) placing a cover which has holes, onto the opening such that one connecting contact threaded rod in each case projects through an associated hole,

d) connection of the cover to the housing such that the opening is closed forming a seal,

e) placing of at least one insulating bush onto the cover with in each case one section of the insulating bush extending into the intermediate space of an associated connecting contact threaded rod and the hole in the cover, and

f) screwing in each case one tightening nut onto an associated connecting contact threaded rod and bracing of the sealing ring and of the insulating bush to the cover in order to close the hole forming a seal,

g) connection of a U-shaped connection profile to the connecting contact threaded rods of an electrode plate stack, and

h) insertion of a housing of an adjacent rechargeable battery into the connection profile such that two parallel flank sections, which extend away from a base section of the connection profile which is connected to the connecting contact threaded rods, surround and make electrical contact with the housing of the adjacent rechargeable battery.

### BRIEF DESCRIPTION OF THE DRAWINGS

The invention will be explained in more detail in the following text using one exemplary embodiment and with reference to the attached drawings, in which:

FIG. 1 shows a section side view of a first embodiment of the rechargeable battery;

FIG. 2 shows a plan view of a connecting contact sheet having contact lugs for the negative electrode plates;

FIG. 3 shows a side view of an output contact sheet for the positive electrode plates with welded-on connecting contact threaded rods;

FIG. 4 shows a plan view of the cover of the housing with the connecting contact threaded rods for the positive pole passing through;

FIG. 5 shows a partial section side view of the rechargeable battery shown in FIG. 1 during the production step of welding the cover to the housing;

FIG. 6 shows a partial section side view of the rechargeable battery shown in FIG. 5 after the step of welding the cover to the housing in order to seal the hole in the cover;

FIG. 7 shows a side view of a second embodiment of the rechargeable battery with a section view of an insulating bush which covers the area of the cover;

FIG. 8 shows a plan view of an insulating bush in the form of a spacer;

FIG. 9 shows a side view of a rechargeable battery with an insulating bush as shown in FIGS. 7 and 8, and with cooling channels created in this way;

FIG. 10 shows a side view of a rechargeable battery block with a plurality of series-connected rechargeable batteries; and

FIG. 11 shows a plan view of the rechargeable battery block shown in FIG. 10, with three rows of rechargeable batteries arranged alongside one another.

### DETAILED DESCRIPTION

According to an exemplary embodiment, a rechargeable battery includes a cuboid housing, an electrode plate stack, which has a multiplicity of positive and negative electrode plates which are separated from one another by intermediate separators and are arranged alternately one above the other, as well as electrolyte in the housing, which has an opening (which can be closed by a cover) for insertion of the electrode plate stack, with the positive electrode plates being connected to one another on a first side edge of the electrode plate stack, with the negative electrode plates being connected to one another on the second side edge, opposite the first side edge, of the electrode plate stack, and with the negative electrode plates making electrical contact with the inner face of the housing.

The negative electrode plates are connected to an output contact sheet which has bent-around contact lugs, and the contact lugs extend from the second side edge to the first side edge of the electrode plate stack, whilst in a sprung manner on the inner face of the housing and form an electrical contact with the housing. A connection profile which can be electrically and mechanically connected to connecting contacts of the positive electrode plates and has a U-shaped base section extending parallel to the cover, and two parallel flank sections are provided, which extend away from the base section and are arranged in order to surround and to make electrical contact with the housing of an adjacent rechargeable battery.

In the cuboid housing, the bent-around contact lugs of the output contact sheet ensure compensation for manufacturing tolerances and that good electrical contact is made with the housing. A good electrical connection with simple assembly is ensured in conjunction with the U-shaped base section, which surrounds the housing, preferably in the area of the contact lugs, of the connection profile.

The connection of the positive poles to the housing which forms a negative connecting pole of an adjacent rechargeable battery is therefore made by the U-shaped connection profiles, which are electrically and mechanically connected to the connecting contact threaded rods of a rechargeable battery. The connection can be made, for example, by screw connection or welding. The U-shaped connection profile has a base section which extends parallel to the cover and is connected to the connecting contact threaded rods, as well as two parallel flank sections, which extend away from the base section and are arranged such that the flank sections surround the housing of an adjacent rechargeable battery, and make electrical contact with it. For this purpose, the flank sections can be additionally welded to the housing.

In one preferred embodiment, at least one connecting contact threaded rod is provided on the first side edge of the electrode plate stack, forms and makes an electrical contact with the positive electrode plates, projects from the first side edge and is passed through an associated hole in the cover. A sealing ring surrounds the connecting contact threaded rod and rests on the inner face of the cover. An insulating bush as an electrical insulator surrounds the connecting contact threaded rod, rests on the outer face of the cover and extends into the hole in the cover. A tightening nut is screwed to the connecting contact threaded rod, and is placed on the insulating bush in order to brace the sealing ring and the insulating bush against the cover.

The use of a connecting contact threaded rod to form the positive pole allows the sealing ring and the insulating bush to be braced mechanically in order to seal the pole bushings in the cover. This embodiment has the advantage that the sealing ring and the insulating bush are not subject to any significant thermal load during production, since the cover can be welded to the housing first of all without the sealing ring and the insulating bush resting firmly against the cover. The sealing ring and the insulating bush are braced by means of the tightening screw only after the cover has cooled down. This embodiment also has the advantage that it ensures simple and low-cost assembly of the rechargeable battery.

The external circumference of the cover should be welded to the housing forming a seal. However, it is also additionally or alternatively possible for the cover to be crimped to the housing.

It is particularly advantageous for the insulating bush to extend over the area of the cover, and to have sleeve sections for insertion into associated holes in the cover. This means that a single element placed on the cover ensures that the rechargeable battery is not shorted by the cover making contact with the housing of an adjacent rechargeable battery.

The insulating bushes are preferably designed such that they have two parallel spacers which each extend at least partially from the cover ring on the mutually opposite outer walls of the housing. The spacers should have ribs at a distance from one another in order to create cooling channels between adjacent rechargeable batteries. The insulating bushes can therefore additionally be used at the same time to avoid shorting between the rechargeable batteries in a rechargeable battery block. At the same time, the ribs at a distance from one another ensure that an air or fluid cooling flow can be drawn between the rechargeable batteries in the rechargeable battery block in order to effectively dissipate heat.

In order to compensate for height differences, a metal foam can be provided between the connecting ends of the negative and/or positive electrode plates and an associated output contact sheet. A metal foam such as this, for example nickel foam, has the advantage because of its deformability of compensating in a simple and reliable manner for minor height differences between the electrode edges during the welding process for connection of the output contact sheet to the connecting ends of the electrode plates, thus allowing all of the electrode plates to be linked securely.

The sealing rings are preferably in the form of O-rings composed of material containing rubber (for example EPDM ethylene/propylene-diene-terpolymer).

The gas pressure-relief valves which may be passed out of one side edge of the housing are preferably connected to one another by means of a flexible gas outlet tube in a rechargeable battery block in order to allow any gas which may emerge to be carried to the exterior out of a rechargeable battery block.

For insulation purposes, the rechargeable batteries are preferably coated with a plastic film, a shrink sleeve or an insulating varnish. In this case, it is advantageous for a row of rechargeable batteries which are connected to one another to be insulated jointly.

According to an exemplary embodiment, a method of producing the rechargeable batteries described above, and of rechargeable battery blocks formed from them, includes the following steps:

a) insertion of an electrode plate stack having an output contact sheet, which has sprung contact lugs on the negative electrode plates into the housing of the rechargeable battery such that the contact lugs rest in a sprung manner against the inner face of the housing, and at least one connecting contact threaded rod on the side edge opposite the output contact sheet of the electrode plate stack projects out of the opening in the housing through which the electrode plate stack is inserted into the housing;

b) fitting of sealing rings to the at least one connecting contact threaded rod,

c) placing a cover which has holes, onto the opening such that one connecting contact threaded rod in each case projects through an associated hole,

d) connection of the cover to the housing such that the opening is closed forming a seal,

e) placing of at least one insulating bush onto the cover with in each case one section of the insulating bush extending into the intermediate space on an associated connecting contact threaded rod and the hole in the cover, and

f) screwing in each case one tightening nut onto an associated connecting contact threaded rod and bracing of the sealing ring and of the insulating bush to the cover in order to close the hole forming a seal,

g) connection of a U-shaped connection profile to the connecting contact threaded rods of an electrode plate stack, and

h) insertion of a housing of an adjacent rechargeable battery into the connection profile such that two parallel flank sections, which extend away from a base section of the connection profile which is connected to the connecting contact threaded rods, surround and make electrical contact with the housing of the adjacent rechargeable battery.

The assembly step sequence ensures good contact without the need for tight manufacturing tolerances, and ensures that the sealing ring and the insulating bush are not damaged when the cover is being welded to the housing.

FIG. 1 shows a side view, in the form of a section, of a rechargeable battery 1 in which an electrode plate stack 2 has been pushed into a housing 3. A gas pressure-relief valve 4 is arranged on a side wall of the housing 3 in order to pass gas to the exterior out of the rechargeable battery 1, at a defined over-pressure, via a T-piece 5, which is plugged onto the gas pressure-relief valve 4, and a flexible gas outlet tube 6.

The negative electrode plates of the electrode plate stack 2 are welded to an output contact sheet 7 which has a multiplicity of sprung contact lugs 8, which are bent around and extend parallel to the electrode plate stack 2. The contact lugs 8 rest against the inner face of the housing 3 when, as illustrated, the electrode plate stack 2 has been pushed into the housing 3.

The positive electrode plates are welded to an output contact sheet 9 on the first side edge, opposite the second side edge, with the output contact sheet 7 for the negative electrode plates. Two connecting contact threaded rods 10a, 10b are fitted to the output contact sheet 9 at a distance from one another and make electrical contact with the positive electrode plates. One sealing ring 11 surrounds each of the associated connecting contact threaded rods 10a, 10b, in order to form a seal between the output contact sheet 9 and a cover 12, which covers an opening 13 in the housing 3. For this purpose, the cover 12 is welded at the outer edge to the outer edge of the housing 3 in the area of the opening 13.

An insulating bush 14 is placed on the connecting contact threaded rods 10a, 10b and extends into the intermediate space in the hole in the cover 12 and in the connecting contact threaded rod 10a, 10b which has been passed through the hole. The insulating bush 14 has a section in the form of a disk between the cover 12 and a tightening nut 15, which is screwed onto the connecting contact threaded rod 10a, 10b. The connecting contact sheet 9 and the cover 12 are moved relative to one another by means of the tightening nut 15, such that the sealing ring 11 between them is clamped in and ensures that the hole in the cover 12 is reliably sealed.

The insulating bush 14 ensures that no short can occur between the positive pole and the housing 3 which forms the negative pole, even if a load is applied in the area of the hole in the cover 12.

A U-shaped connection profile 16 is welded to the tightening nuts 15 and to the connecting contact threaded rods 10a, 10b. The U-shaped connection profile 16 has a base section, which extends parallel to the cover 12, and two parallel flank sections, which extend away from the base section and are arranged such that the housing 3 of an adjacent rechargeable battery 1 is surrounded and has electrical contact made with it.

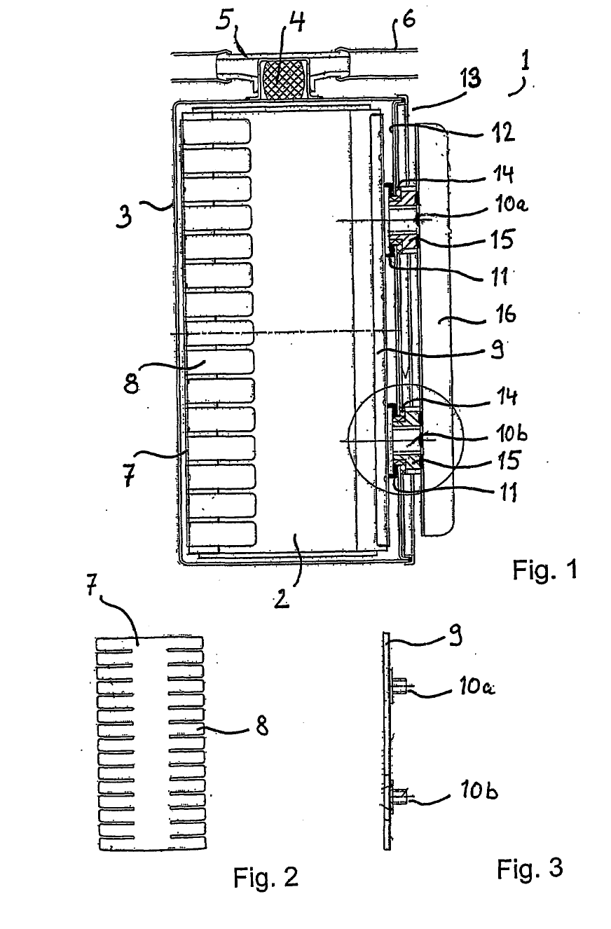

FIG. 2 shows a plan view of the connecting contact sheet 7 for the negative pole. As the figure shows, contact lugs 8 are provided on both longitudinal edges of the connecting contact sheet 7 and are bent around once the connecting contact sheet 7 has been welded in the central area to the ends of the negative electrode plates of the electrode plate stack 2.

FIG. 3 shows a side view of the connecting contact sheet 9 for the positive pole. The connecting contact sheet 9 is welded on the illustrated left-hand side to the ends of the positive electrode plate of the electrode plate stack 2. The two connecting contact threaded rods 10a, 10b project on the opposite side, in order to form the positive pole.

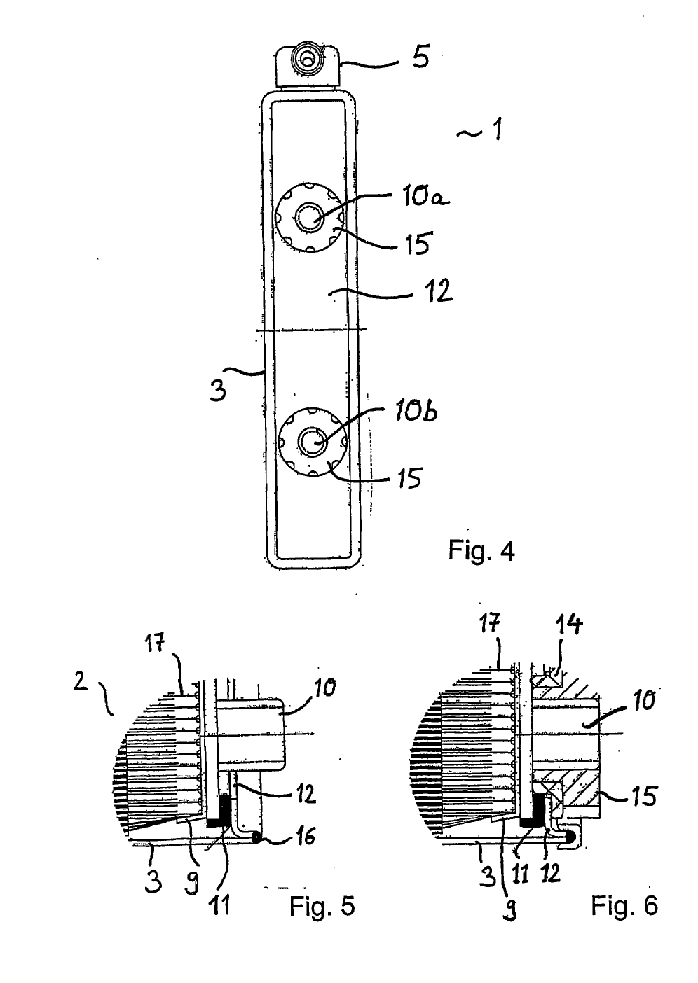

FIG. 4 shows a plan view of the side of the rechargeable battery 1 with the cover 12, and the connecting contact threaded rods 10a, 10b projecting out of it. This clearly shows that the tightening nuts have been screwed onto the connecting contact threaded rods 10a, 10b, in order to brace the cover 12 to the electrode plate stack 2, which is located in the housing 3.

The step sequence for the manufacturing procedure for production of the rechargeable battery 1 will become clearer from FIGS. 5 and 6, which show a detail of the rechargeable battery 1, in the form of a section view in the area of the connecting contact threaded rods 10.

Once the electrode plate stack 2 has been pushed into the housing 3, the sealing ring 11 is placed on the connecting contact threaded rods 10, and the opening in the housing 3 is closed by the cover 12. This cover 12 is then welded to the housing 3 along a weld bead 16, forming a seal.

An insulating bush 14 is then placed on the cover 12 such that in each case one section of the insulating bush 14 extends into the intermediate space of the connecting contact threaded rod 10 and the hole in the cover 12. The tightening nut 15 is then placed on the connecting contact threaded rod 10 and is screwed up in order in this way to brace the sealing ring 11 and the insulating bush 14 to the cover 12, in order to close the hole, forming a seal.

As can also be seen from FIGS. 5 and 6, the ends 17 of the positive electrode plates are welded to the connecting contact sheet 9. The ends of the negative electrode plates are welded to the connecting contact sheet 7 shown in FIG. 2, in a corresponding manner.

It is particularly advantageous for a metal foam, preferably nickel foam, to be introduced between the ends of the electrode plates and the corresponding connecting contact sheet 7, 9, in order to compensate for height differences for the welding process and to ensure that the ends of the electrode plates reliably make contact with the output contact sheet 7, 9. This is achieved by the deformation capability of the metal foam.

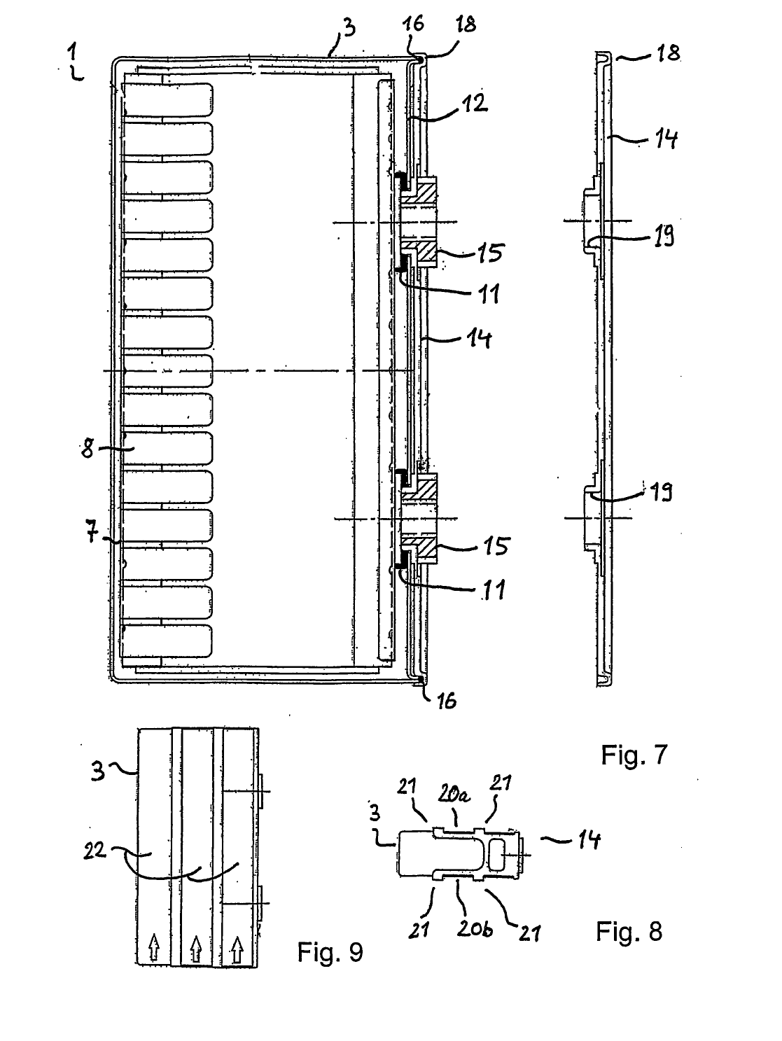

FIG. 7 shows a second embodiment of the rechargeable battery 1, in which the insulating bush 14 is formed integrally, in contrast to the first embodiment, and extends essentially over the area of the cover 12 and the opening in the housing 3. As can be seen, a circumferential groove 18 is provided on the outer edge of the insulating bush 14 and is plugged onto the connection edge between the housing 3 and the cover 12 with the weld bead 16. In the area of the associated holes in the cover 12, the insulating bush has sleeve sections 19 which extend into the hole in the cover 12 once the insulating bush 14 has been placed on the opening in the housing 3.

An insulating bush 14 such as this reliably protects the corresponding side edge of the rechargeable battery 1 against contacts forming shorts.

FIG. 8 shows a view of one embodiment of the insulating bush 14, which has two parallel spacers 20a, 20b, which extend away from outer walls of the housing 3 which are in each case opposite the contact surface for the cover 12 and the tightening nut 15, and have ribs 21 at a distance from one another, with at least one rib 21 being provided on each side. The spacers 20 with the ribs 21 ensure that rechargeable batteries 1 which are arranged alongside one another do not touch and in consequence possibly cause a short. Furthermore, as can be seen from the side view of a rechargeable battery 1 in FIG. 9, cooling channels 22 are created. Air can flow parallel to the rechargeable battery axis through the cooling channels 22.

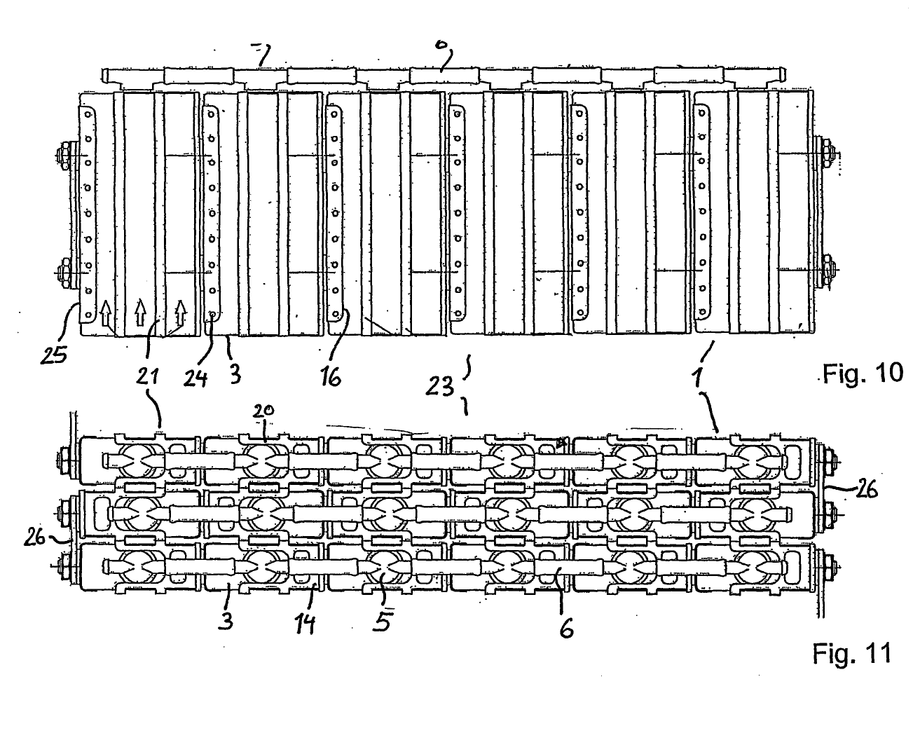

FIG. 10 shows a side view of a rechargeable battery block 23 in which a plurality of rechargeable batteries 1 are connected in series. For this purpose, the U-shaped connection profile 16, which is connected to the connecting contact threaded bolt 10 and tightening nuts 5, is welded at the weld points 24 to the housing 3 of the adjacent rechargeable battery 1. The welding is carried out on the flank sections from the side, so that the weld positions of the weld points 24 are easily accessible. Holes are preferably provided in the flank sections of the connection profile 16, for spot welding.

Furthermore, FIG. 10 shows the connection of the gas pressure-relief valves to the T-pieces 5 and the flexible gas outlet tubes 6.

The left end of the rechargeable battery block 23 is welded to a closure connection profile 25, to which screw connectors are fitted for electrical connection of the rechargeable battery block 23.

FIG. 11 shows a plan view of a rechargeable battery block 23 which comprises three longitudinal rows of rechargeable batteries 1. This clearly shows that the rows of rechargeable battery blocks 1 are alternately each rotated through 180°, so that the negative pole connection can be connected at one connecting end to the positive pole connection of an adjacent row of rechargeable batteries 1, with the aid of cross-connectors 26.

Furthermore, the cooling channels 22 formed by the ribs 21 on the spacers 20 can be seen, through which air can flow from the bottom upwards through the rechargeable battery block 23. The figure also clearly shows that the rows of rechargeable batteries 1 are kept at a distance from one another by the spacers 20.

This allows a plurality of rechargeable battery modules to be connected to one another as required to form a battery group, in order to form a cell group. Since the metallic walls of the rechargeable batteries 1 must not touch one another, in order to avoid shorts, the rechargeable batteries 1 are coated with a thin plastic film before further processing, or are electrically isolated from the surrounding area by the application of an insulating varnish. The plastic layer can be applied by a sheathing in the form of a shrink sleeve, which rests against the outer walls on heating. The rechargeable batteries 1 can also be insulated from one another by tight fitting of the rechargeable batteries 1 into a thin-walled plastic shell with a U-shaped profile.

The insulating varnish can be applied by means of a dipping process, which in some circumstances may have a plurality of stages, or a spraying process. Once the solvent has dried out, this results in external electrical insulation over the entire rechargeable battery block 23. In addition to the electrical protective function, insulation such as this has the characteristic of protecting the housings 3 of the rechargeable batteries 1 against corrosion.

1-14. (canceled)

15. A rechargeable battery comprising:
a housing having an electrode plate stack and an electrolyte provided therein, the electrode plate stack comprising a plurality of positive electrode plates and negative electrode plates separated from one another by separators, the positive electrode plates being connected to one another on a first side edge of the electrode plate stack and the negative electrode plates being connected to one another on the second side edge of the electrode plate stack that is opposite the first side edge, the negative electrode plates making electrical contact with an inner face of the housing, the housing further comprising a cover;
an output contact sheet connected to the negative electrode plates and comprising bent-around contact lugs, the contact lugs extending from the second side edge to the first side edge of the electrode plate stack, the contact lugs contacting in a sprung manner the inner face of the housing such that they are in electrical contact with the housing; and
a connection profile coupled to connecting contacts of the positive electrode plates and having a U-shaped base section extending parallel to the cover and two parallel flank sections that extend away from the base section, the parallel flank sections arranged such that they surround and make electrical contact with a housing of an adjacent rechargeable battery.

16. The rechargeable battery of claim 15, further comprising:
at least one connecting contact threaded rod provided on the first side edge of the electrode plate stack that is in electrical contact via an output contact sheet with the positive electrode plates, the rod projecting from the first side edge and through an associated hole in the cover,
a sealing ring surrounding the connecting contact threaded rod and resting on the inner face of the cover;
an electrically insulating bushing surrounding the connecting contact threaded rod and resting on the outer face of the cover and extending into the hole in the cover; and
a tightening nut screwed to the connecting contact threaded rod and placed on the insulating bushing to brace the sealing ring and the insulating bushing against the cover.

17. The rechargeable battery of claim 15, further comprising metal foam provided between the connecting ends of at least one electrode plate and an associated output contact sheet.

18. The rechargeable battery of claim 15, wherein the cover comprises an external circumference that is welded to the housing to form a seal.

19. The rechargeable battery of claim 16, wherein the insulating bushing extends over the area of the cover and has sleeve sections for insertion into associated holes in the cover.

20. The rechargeable battery of claim 15, further comprising two parallel spacers which each extend from the housing, the spacers provided on the insulating bushing and having ribs at a distance from one another to create cooling channels between adjacent rechargeable batteries.

21. The rechargeable battery of claim 16, wherein the sealing ring is in the form of an O-ring and comprises a material comprising rubber.

22. The rechargeable battery of claim 15, further comprising a gas pressure-relief valve which passes out of one side edge of the housing.

23. A rechargeable battery block comprising:
a plurality of rechargeable batteries, each of the rechargeable batteries comprising:
(a) a housing having an electrode plate stack and an electrolyte provided therein, the electrode plate stack comprising a plurality of positive electrode plates and negative electrode plates separated from one another by separators, the positive electrode plates being connected to one another on a first side edge of the electrode plate stack and the negative electrode plates being connected to one another on the second side edge of the electrode plate stack that is opposite the first side edge, the negative electrode plates making electrical contact with an inner face of the housing, the housing further comprising a cover; and
(b) an output contact sheet connected to the negative electrode plates and comprising bent-around contact lugs, the contact lugs extending from the second side edge to the first side edge of the electrode plate stack, the contact lugs contacting in a sprung manner the inner face of the housing such that they are in electrical contact with the housing; and
wherein at least some mutually adjacent rechargeable batteries are electrically and mechanically connected to a U-shaped connection profile, with two parallel flank sections, which extend away from a base section, surrounding the housing of one rechargeable battery and being welded to the housing, and with the base section being connected to the at least one connecting contact threaded rod of the adjacent rechargeable battery.

24. The rechargeable battery block of claim 23, wherein each of the rechargeable batteries further comprises a gas pressure-relief valve which passes out of one side edge of the housing, and wherein gas pressure-relief valves in a sequence of mutually adjacent rechargeable batteries are connected to a flexible gas outlet tube.

25. The rechargeable battery block of claim 23, wherein the rechargeable batteries are coated with one of a plastic film, a shrink sleeve, and an insulating varnish.

26. A method for producing a rechargeable battery group comprising:
providing an electrode plate stack in a housing, the electrode plate stack comprising an output contact sheet having sprung contact lugs on the negative electrode plates; the contact lugs resting in a sprung manner against an inner face of the housing, the electrode plate stack also comprising at least one connecting contact threaded rod on the side edge opposite the output contact sheet of the electrode plate stack, the rod projecting out of an opening in the housing through which the electrode plate stack is introduced into the housing;
fitting sealing rings to the at least one connecting contact threaded rod;
placing a cover comprising a plurality of holes over the opening such that one connecting contact threaded rod in each case projects through an associated hole;
coupling the cover to the housing such that the opening is closed to form a seal;
placing at least one insulating bushing onto the cover, the insulating bushing extending into an intermediate space between a connecting contact threaded rod and a hole in the cover;
screwing a tightening nut onto each connecting contact threaded rod and bracing the sealing ring and the insulating bushing to the cover in order to close the hole forming a seal;
connecting a U-shaped connection profile to the connecting contact threaded rods of an electrode plate stack; and
inserting a housing of an adjacent rechargeable battery into the connection profile such that two parallel flank sections, which extend away from a base section of the connection profile which is connected to the connecting contact threaded rods, surround and make electrical contact with the housing of the adjacent rechargeable battery.

27. The method of claim 26, further comprising welding flank sections to the housing of the adjacent rechargeable battery.

28. The method of claim 26, wherein the rechargeable batteries comprise gas pressure-relief valves and further comprising connecting the gas pressure-relief valves to a common flexible gas outlet tube.
